(19) United States
(12) Patent Application Publication
(10) Pub. No.: US 2014/0037114 A1
(43) Pub. Date: Feb. 6, 2014

(54) FLAT TYPE SPEAKER HAVING VIBRATION-LEAD PLATE ATTACHED ON TOP OF VIBRATION PLATE

(71) Applicant: Dong-Man Kim, Seoul-si (KR)

(72) Inventor: Dong-Man Kim, Seoul-si (KR)

(73) Assignee: EXELWAY INC., Seoul (KR)

(21) Appl. No.: 13/985,145

(22) PCT Filed: Feb. 13, 2012
(86) PCT No.: PCT/KR12/01038

§ 371 Date: Oct. 21, 2013

(30) Foreign Application Priority Data
Feb. 16, 2011 (KR) 10-2011-0013784

(51) Int. Cl. H04R 1/00

(52) U.S. Cl. CPC H04R 1/00
USPC 381/162

(57) ABSTRACT

The present invention relates to a flat type speaker, and more particularly, to a flat type speaker of a vibration-lead plate of a voice coil plate, improving the quality deterioration due to the reduction of production process and the disconnection of a lead wire, by being attached to the top of a voice coil plate, increasing vibration efficiency, and eliminating the lead wire connection of the voice coil. The flat type speaker of a vibration-lead plate of a voice coil plate according to the present invention comprises: a pair of magnetic bodies having a magnet and a yoke formed side by side, separated at a predetermined interval; a voice coil plate inserted in the space between the magnetic bodies, and having formed thereon a voice coil with a spiral pattern printed thereon; a vibration-lead plate having a first vibration-lead plate and a second vibration-lead plate, which are physically separated, each having +, − terminals formed on the front ends thereof, wherein the first and the second vibration-lead plates are each equipped with a coil plate spline, which adheres to the upper end of the voice coil plate, and at least one wing spline having one end thereof connected to the coil plate spline and the other end connected to the + or − terminals; and a vibration plate, which vibrates from the vibration received from the voice coil plate, while being contacted to the upper end portion of the vibration-lead plate.

### TECHNICAL FIELD

The present invention relates to a flat type speaker and, more particularly, to a flat type speaker having damper-lead plates mounted on the top of a vibration plate, which can improve vibration efficiency by mounting the damper-lead plates on the top of the vibration plate, reduce a production process by eliminating lead wires through the direct soldering of the damper-lead plates to a voice coil, and improve the deterioration of quality due to the disconnection of a lead wire.

### BACKGROUND ART

A speaker is equipped with a voice coil and a vibration plate interposed between magnets, and the speaker generates sound when the vibration plate is vibrated by a movement of the voice coil.

A flat type speaker includes a flat type voice coil and magnets disposed on both sides of the flat type voice coil and spaced apart from each other at a specific interval. In this flat type speaker, induced electromotive force is generated according to Fleming's left-hand law and Lorentz's force, a frequency according to a voice is formed, and the frequency vibrates the vibration plate, thereby being reproduced into sound.

The voice coil is wound in an oval form or patterned and printed on one or both sides of a plate type coil base, thus forming a voice coil plate.

A vibration plate is attached to the top of the voice coil plate in a length direction. The vibration plate is vibrated in response to a movement of the voice coil plate, thereby generating sound.

Furthermore, the voice coil formed in the voice coil plate is bonded to both terminals of a base frame that forms the outside of + and − lead wires, thereby forming a circuit.

In a conventional voice coil plate, however, a contact area with the vibration plate is small because the voice coil plate is adhered to the vibration plate in an upright state. As a result, the transfer of vibration energy is limited.

Furthermore, since the lead wires formed in the voice coil plate are bonded to the base frame, a problem in which the bonding is broken because the voice coil plate is moved up and down, but the base frame is fixed is frequently generated.

Furthermore, in general, the lead wires of the voice coil plate are connected to the terminals of the base frame using a soldering method, but this method is problematic in that the quality of the speaker is deteriorated.

### DISCLOSURE

### Technical Problem

Accordingly, the present invention has been made to solve the conventional problems, and an object of the present invention is to transfer more sound energy by mounting damper-lead plates on the top of a vibration plate, in particular, in the edge space of the vibration plate.

Another object of the present invention is to eliminate a problem in which lead wires are connected by soldering for electrical connection from a voice coil to the terminals of a base frame, reduce a manufacturing process by implementing electrical connection through direct soldering to the voice coil, and solve a quality deterioration problem attributable to the connection of the lead wires.

### Technical Solution

To achieve the above objects, a flat type speaker having damper-lead plates mounted on a vibration plate according to the present invention includes a pair of magnetic bodies spaced apart from each other at a specific interval, formed side by side, and each having a magnet and yorks formed therein; a voice coil plate inserted into an interval between the magnetic bodies and having a voice coil spirally patterned and printed formed therein; damper-lead plates including first and second damper-lead plates physically separated and having + and − terminals formed at the respective front ends of the damper-lead plates, wherein each of the first and the second damper-lead plates includes a coil plate spline adhered to the top of the voice coil plate and one or more wing splines having one end connected to the coil plate spline and the other end connected to the + or − terminal; and a vibration plate vibrated in response to the vibration of the voice coil plate with the vibration plate coming in contact with a top of the damper-lead plates.

Here, the wing splines preferably are implemented so that they are brought in contact with a bottom of the vibration plate.

Here, the first and the second damper-lead plates may be made of conductive and metallic materials, and the second damper-lead plate may be symmetrical to the first damper-lead plate and rotated by 180 degrees from the first damper-lead plate.

Here, the first and the second damper-lead plates may be made of insulating materials and formed of one body, and the first and the second damper-lead plates may be coated with conductive materials in such a way as to be electrically separated.

Each of the first and the second damper-lead plates preferably may include a lead block connected to the front end of the voice coil by soldering at a front end on one or the other side of the coil plate spline or at front ends on both sides of the coil plate spline.

The width of the coil plate spline preferably may be smaller than or equal to the thickness of the voice coil plate, and the width of the lead block preferably may be greater than the width of the coil plate spline.

### Advantageous Effects

In accordance with the construction of the present invention, more sound energy can be transferred by mounting the damper-lead plates on the top of the vibration plate, in particular, in the edge space of the vibration plate. Furthermore, a problem in which lead wires are connected by soldering for electrical connection from the voice coil to the terminals of the base frame can be eliminated, a manufacturing process can be reduced by implementing electrical connection through direct soldering to the voice coil, and a quality deterioration problem attributable to the connection of the lead wires can be solved.

### DESCRIPTION OF DRAWINGS

FIG. 1 is a perspective view of a flat type speaker having damper-lead plates mounted on the top of a vibration plate according to the present invention.

FIG. 2 is an exploded perspective view of the flat type speaker having damper-lead plates mounted on the top of a vibration plate according to the present invention.

FIG. 3 is a perspective view of the damper-lead plates according to the present invention.

FIG. 4 is a perspective view of the connection structure of the voice coil plate and the damper-lead plates according to the present invention.

### MODE FOR INVENTION

Hereinafter, the construction and effects of a flat type speaker having damper-lead plates mounted on the top of a vibration plate according to the present invention are described with reference to the accompanying drawings.

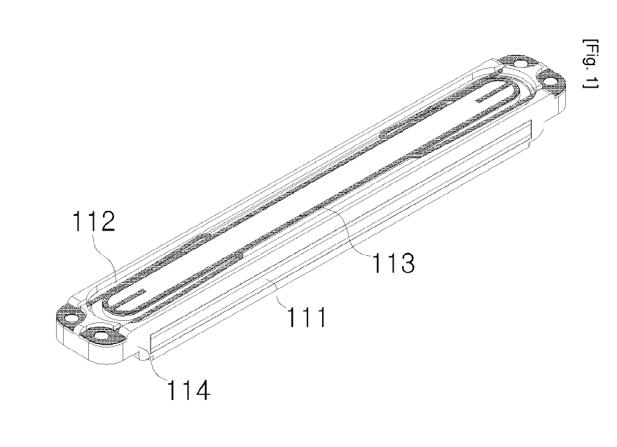

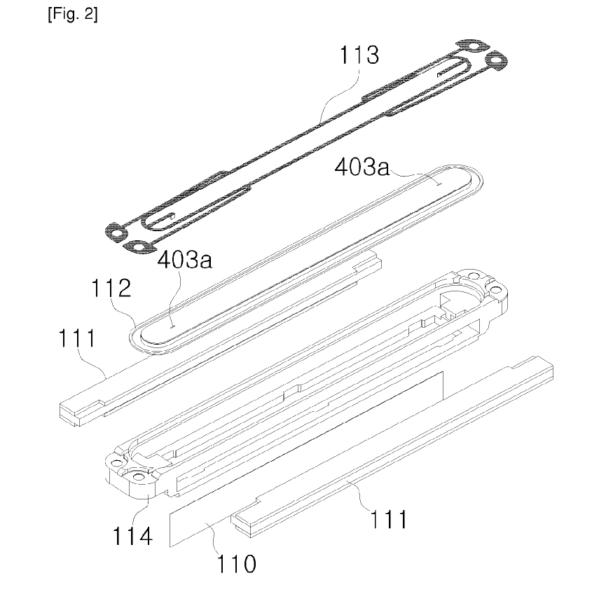

FIG. 1 is a perspective view of a flat type speaker having damper-lead plates mounted on the top of a vibration plate according to the present invention, and FIG. 2 is an exploded perspective view of the flat type speaker having damper-lead plates mounted on the top of a vibration plate according to the present invention.

As shown in FIG. 1 and FIG. 2, the flat type speaker having damper-lead plates mounted on the top of a vibration plate according to the present invention includes a voice coil plate 110 on which a voice coil wound or patterned and printed in a track form is patterned and printed, a pair of magnetic bodies 111 spaced apart from each other at a specific interval on the left and right of the voice coil plate 110, a vibration plate 112 connected to the top of the voice coil plate 110 and transferring vibration energy in a sound form, a pair of damper-lead plates 113 mounted on the top of the vibration plate 112 and configured to assist up and down movements of the voice coil plate 110 and to have leads electrically connected to the voice coil formed therein, and a base frame 114 made of synthetic materials, which forms the outside and with which various parts can be combined.

Each of the magnetic bodies 111 can include a magnet at the center thereof and yorks or magnet plates combined on and below the magnet. The pair of magnetic bodies 111 are spaced apart from each other at a specific interval and formed side by side, and the voice coil plate 110 is inserted into the interval between the formed magnetic bodies 111.

The flat type speaker of the present invention includes the voice coil plate 110 and the magnetic bodies 111 disposed on both sides of the voice coil plate 110 with a specific interval interposed therebetween. When a current flows in the voice coil, induced electromotive force is generated according to Fleming's left-hand law and Lorentz's force, and the voice coil plate 110 is moved up and down in response to the induced electromotive force.

Here, the vibration plate 112 formed on the voice coil plate 110 is vibrated while operating in conjunction with the up and down movements of the voice coil plate 110.

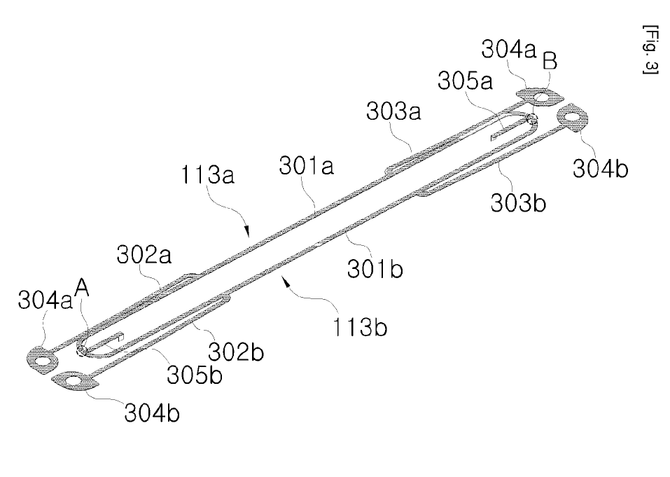

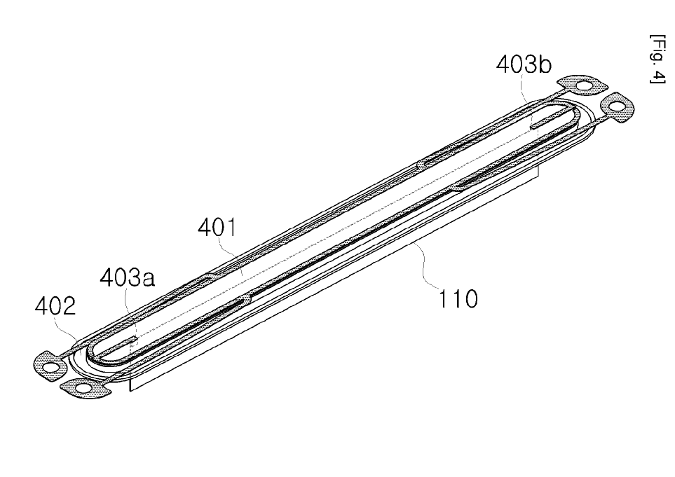

The damper-lead plates 113 are configured to be mounted on the top of the vibration plate 112, and the mounting structure is described in more detail below with reference to FIGS. 3 and 4.

The damper-lead plates 113 include two plates having a symmetrical structure in such a manner that the two plates are physically separated from each other and configured to face each other in the state in which one of the two plates is rotated by 180 degrees. Each of the damper-lead plates 113 is configured to have + and − terminals for power connection formed at both ends thereof, and the + and − terminals are mounted on both ends of a previously fabricated base frame 114.

Thus, the vibration of the damper-lead plates 113 having a damper function is added to the vibration of the vibration plate 112 vibrated in response to the vibration of the voice coil plate 110, so that more sound energy is transferred. Furthermore, the + and − terminals are formed at both ends of the damper-lead plates 113, and the power wire of the voice coil 110a is connected to one side of the damper-lead plates 113 by soldering. Accordingly, the damper-lead plates 113 function as lead wires for connecting the voice coil 110a and + and − terminals mounted on the base frame 114.

The structure of the damper-lead plates and the mounting structure of the damper-lead plates, the vibration plate, and the voice coil plate to be implemented by the present invention are described in detail below with reference to FIGS. 3 and 4.

FIG. 3 is a perspective view of the damper-lead plates according to the present invention, and FIG. 4 is a perspective view of the connection structure of the voice coil plate and the damper-lead plates according to the present invention.

The damper-lead plates 113 are mounted on the top of the vibration plate 112, and the damper-lead plates 113 function to maximize sound energy output by vibrating more vibration energy along with the vibration plate 112. Furthermore, the + and − terminals are formed at both ends of the damper-lead plates 113, and the damper-lead plates 113 are formed of metal plates (or formed by coating insulating material plates with conductive material). Accordingly, soldering connection with lead wires that was used for circuit connection with an existing voice coil can be eliminated, a failure due to the disconnection of a lead wire can be prevented by replacing the role of the lead wires with the metal plates, and difficulties in the process can be solved.

Various splines that form the damper-lead plates 113 mean slim, long, and thin plates, such as metal, in a dictionary definition.

Referring to FIGS. 3 and 4, the damper-lead plates 113 of the flat type speaker according to the present invention include a pair of a first damper-lead plate 113a and a second damper-lead plate 113b on the left and right.

The first and the second damper-lead plates 113a and 113b are physically separated from each other (A, B) and are formed of metallic thin films having conductivity. One of the first and the second damper-lead plates 113a and 113b forms a circuit using the + terminal, and the other thereof forms a circuit using the − terminal.

Alternatively, although not shown, the first and the second damper-lead plates 113a and 113b can be integrally formed physically and made of insulating materials. Here, the first and the second damper-lead plates 113a and 113b can be coated with conductive materials so that they are electrically separated. As a result, one of the first and the second damper-lead plates 113a and 113b can form the circuit using the + terminal and the other thereof can form the circuit using the − terminal.

The second damper-lead plate 113b is rotated by 180 degrees from a line vertical to a reference line, that is, a specific parallel slant line in the length direction of the first damper-lead plate 113a, in the state in which the second damper-lead plate 113b is symmetrical to the first damper-lead plate 113a on the basis of the reference line.

The reason why the first and the second damper-lead plates 113a and 113b are symmetrical to each other left and right and up and down is to take advantages of a production process by making the first and the second damper-lead plates 113a and 113b substantially have the same structure. This reason is for equally maintaining the transfer of vibration energy on the left and right sides along with the vibration plate 112, but there is no problem although the first and the second damper-lead plates 113a and 113b have different structures.

The first damper-lead plate 113a includes a vibration plate spline 301a, first and second wing splines 302a and 303a, a pair of terminals 304a, and a lead block 305a, which are integrally coupled seamlessly. Likewise, the second damper-lead plate 113b includes a vibration plate spline 301b, first and second wing splines 302b and 303b, a pair of terminals 304b, and a lead block 305b, which are integrally coupled seamlessly.

The vibration plate splines 301a and 301b are parts adhered to the outer line of the main body 401 of the vibration plate 112. The wing splines 302a, 303a and 302b, 303b are protruded from one points of the vibration plate splines 301a and 301b, bent in opposite directions, and then placed on the edge (402) parts of the vibration plate 112 in a non-contact state, thus perform a damper function.

The vibration plate splines 301a and 301b and the wing splines 302a, 303a and 302b, 303b are lengthily formed in a length direction with a slim width.

One end of each of the vibration plate splines 301a and 301b is configured to be protruded in such a way to be oriented downward in a ‘ [symbol] ’ form. Blocks each having the ‘ [symbol] ’ form are called the lead blocks 305a and 305b.

The lead blocks 305a and 305b are integrally formed with the vibration plate splines 301a and 301b and configured to penetrate vibration plate holes 403a and 403b formed in the main body 401 of the vibration plate 112.

The lead blocks 305a and 305b that penetrate the vibration plate holes 403a and 403b function as the central guide of the voice coil plate 110 and also function as a + and − connection function through soldering with the voice coil 110a of the voice coil plate 110 placed under the vibration plate 112.

The terminals 304a and 304b are formed at the front ends of the wing splines 302a, 303a and 302b, 303b.

The terminals 304a and 304b are mounted on a power terminal pole formed in the base frame 114. One of the terminals 304a and 304b is used as a + terminal, and the other thereof is used as a − terminal.

The lead blocks 305a and 305b are connected to the + and − wire parts of the voice coil 110a of the voice coil plate 110 by soldering. The lead blocks 305a and 305b are integrally connected to the first and the second damper-lead plates 113a and 113b and connected to the terminals 304a and 304b formed at the front ends of the first and the second damper-lead plates 113a and 113b, thereby completing electrical connection up to the voice coil 110a and the terminals 304a and 304b.

Existing connection between a voice coil and the terminal pole of a base frame was implemented by a process of soldering lead wires. In this case, a work process is problematic, and a phenomenon in which a lead wire is broken because the terminal pole of the base frame is fixed and a voice coil plate is moved up and down can be generated. The damper-lead plates 113 of the present invention can supplement the conventional problem.

As described above, the damper-lead plates 113 are configured to be connected to the vibration plate 112 in the form of a sheet spring in such a way as to transfer more sound energy to the vibration plates 112, thereby being capable of improving the quality of the speaker. Furthermore, the damper-lead plates 113 are formed of metallic thin films, the terminals 304a and 304b are formed on both sides of the damper-lead plates 113, and the lead blocks 305a and 305b are formed at locations corresponding to the voice coil. Accordingly, the efficiency of a production process can be improved and quality can be maintained because a process of connecting the voice coil and the lead wires of the base frame is eliminated.

While preferred embodiments of the present invention have been described with reference to the accompanying drawings, those skilled in the art to which the present invention pertains will understand that the present invention may be implemented in other detailed forms without departing from the technical spirit or essential characteristics of the present invention. Accordingly, the aforementioned embodiments should not be construed as being limitative, but should be construed as being only illustrative from all aspects. Furthermore, the scope of the present invention is defined by the appended claims rather than the detailed description, and it should be understood that all modifications or variations derived from the meanings and scope of the present invention and equivalents thereof are included in the scope of the appended claims.

1. A flat type speaker having damper-lead plates mounted on a vibration plate, comprising:
a pair of magnetic bodies spaced apart from each other at a specific interval, formed side by side, and each having a magnet and yorks formed therein;
a voice coil plate inserted into an interval between the magnetic bodies and having a voice coil spirally patterned and printed formed therein;
a vibration plate brought in contact with a top of the voice coil plate and vibrated in response to a vibration of the voice coil plate; and
first and second damper-lead plates adhered to a top of a main body of the vibration plate and arranged in parallel, each of the first and second damper-lead plates comprising a vibration plate spline having a slim and long plate form, and one or more wing splines having one end connected to the vibration plate spline and having a slim and long plate form.

2. The flat type speaker of claim 1, wherein:
a lead block having a ‘ [symbol] ’ form is formed at one end of the vibration plate spline,
the lead blocks are configured to penetrate vibration plate holes formed in the vibration plate and connected to the voice coil by soldering, and
a + or − terminal is formed at one end of the wing spline.

3. The flat type speaker of claim 1, wherein:
a pair of the wing splines are extended from the vibration plate spline and bent in opposite directions, and
a + or − terminal is formed at a front end of each of the pair of the wing splines.

4. The flat type speaker of claim 1, wherein the wing spline is placed on an edge of the vibration plate.

5. The flat type speaker of claim 1, wherein:
the first and the second damper-lead plates are made of conductive and metallic materials, and
the second damper-lead plate has a symmetrical structure rotated by 180 degrees from the first damper-lead plate.

6. The flat type speaker of claim 1, wherein:
the first and the second damper-lead plates are made of insulating materials and formed of one body, and
the first and the second damper-lead plates are coated with conductive materials in such a way as to be electrically separated.
